(19) United States
(12) Patent Application Publication
(10) Pub. No.: US 2007/0265867 A1
(43) Pub. Date: Nov. 15, 2007

(54) Hairstyling method and apparatus for the same

(76) Inventor: Ching-Yu Lin, Yilan Hsien (TW)

Correspondence Address: COOPER & DUNHAM, LLP, 1185 AVENUE OF THE AMERICAS, NEW YORK, NY, 10036, US

(21) Appl. No.: 11/434,425

(22) Filed: May 12, 2006

(51) Int. Cl. G06Q 10/00; G06Q 30/00

(52) U.S. Cl. 705/1

(57) ABSTRACT

A method and apparatus for a simulative hair design by using computer programming has at least one processing unit, at least one monitor, an image recording device and a permanent device. The at least one processing unit can help hair stylist to design a hairstyle and store customers' data so that the customer can know outcome of hairdo before the hair stylist cut, educate apprentices who study hair design, count storage of expendables for salons or barbershops. The at least one monitor can display image of hairstyle combined with the customer's head image. The image recording device can take image of the customer and stores into the at least one processing unit. The permanent device can receive argument of permanent from the at least one processing unit so that the customer' hair can have well permanent.

### BACKGROUND OF THE INVENTION

1. Field of the Invention

The present invention relates to hairstyling, and more particularly to a hairstyling method and apparatus to simulate a hairstyle design for the purposes of advance preview, educate apprentices studying hairstyling, maintain an inventory of expendables and store customers' data.

2. Description of Related Art

Conventional hairstyling techniques and apparatus are generally stand-along techniques and apparatus and have numerous limitations and shortcomings.

Conventional hairstyling techniques include conventional hairstyle programs, manual hair cutting, styling and permanent processes, manual hairstyle design, training with actual hair, hairstyle design and stand-alone hairstyle supply inventories.

Conventional hairstyle programs are two dimensional (2D) and only use an internal hair-imaging database and an image of a particular client. The hair-imaging database has many images of different hairstyles and capabilities to zoom in, zoom out, change color and combine the foregoing capabilities. The hairstylist initially takes a picture of the customer's head and downloads the image into the hairstyle program. The hairstyle program recalls a particular hair image and a particular customer image and zooms the hair image out and in to mate the hair image with the customer's image and changes the color of the hair image only. However, the hairstyle program cannot make changes other than scale and color to the hair image or the customer's image.

Manual hair cutting, styling and permanent processes are susceptible to greatly varying results. Conventional permanent processes are particularly susceptible and include iron set permanents, straight iron permanents chemical permanents. All permanent processes change the natural characteristics of the hair and to a certain degree always damage the hair. Excessive cutting or permanent treatment is usually irreversible and can be overcome only by letting the hair grow out. Controlling temperature and moisture during the permanent process is particularly important. If the temperature and the moisture are not controlled adequately, resilience of the hair may not be consistent, and the hairstyle after the permanent will not hold as it should.

People wanting to be hair stylists must attend a training institute to be educated and certified as a hair stylist. Virtually all training institute always has more students than training apparatus. The students of the training institute cannot be trained properly due to the lack of training apparatus.

Hair stylists may create a lot of different hair styles during their free time, which must be drawn. However, the drawing of the hairstyle and the implementation of the hairstyle may be tremendously different. The hair stylist needs to practice new hairstyles many times on a real person or a model. Consequently, the development of new hairstyles may be very time-consuming and expensive.

To overcome the shortcomings, the present invention provides a hairstyling method and apparatus to obviate or mitigate the aforementioned problems.

### SUMMARY OF THE INVENTION

The primary objective of the present invention is to provide a hairstyling method using 3D computer technologies and advanced apparatus to be able to consistently design a hairstyle more detailed before a hairstylist starts styling. Moreover, it also can be used to educate apprentices, maintain inventories of expendables and store customers' data.

The hairstyling apparatus has at least one processing unit, at least one monitor, an image recording device and a permanent device. The at least one processing unit can be used to design new and different hairstyle individually, educate apprentices, maintain inventories of expendables, store customers' data and design new hairstyles. The at least one monitor can display images of a particular hairstyle combined with a customer's head image. The image recording device can take images of customers and download the images to the at least one processing unit. The permanent device can be automatically controlled by the at least one processing unit so the desired permanent style is implemented in a customer' hair.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hairstyling apparatus in accordance with the present invention;

FIG. 2 is a flow chart of a hairstyling method in accordance with the present invention; and

FIG. 3 is a block diagram of the at least one processing unit in FIG. 1.

### DETAILED DESCRIPTION OF THE PREFERRED EMBODIMENT

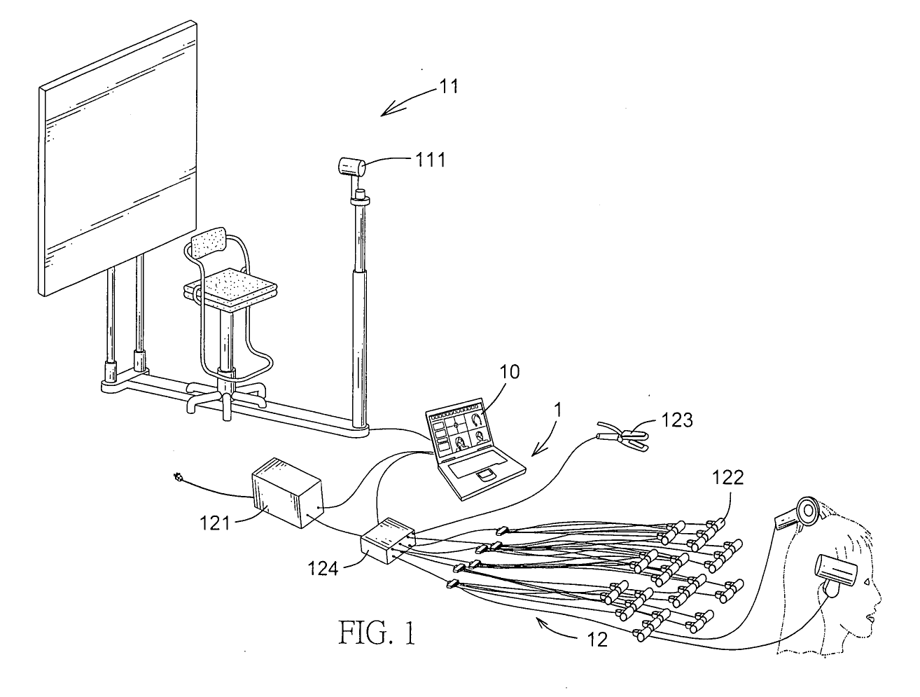

With reference to FIG. 1, a hairstyling apparatus in accordance with the present invention comprises at least one processing unit (1), at least one monitor (10), an image recording device (11) and a permanent device (12).

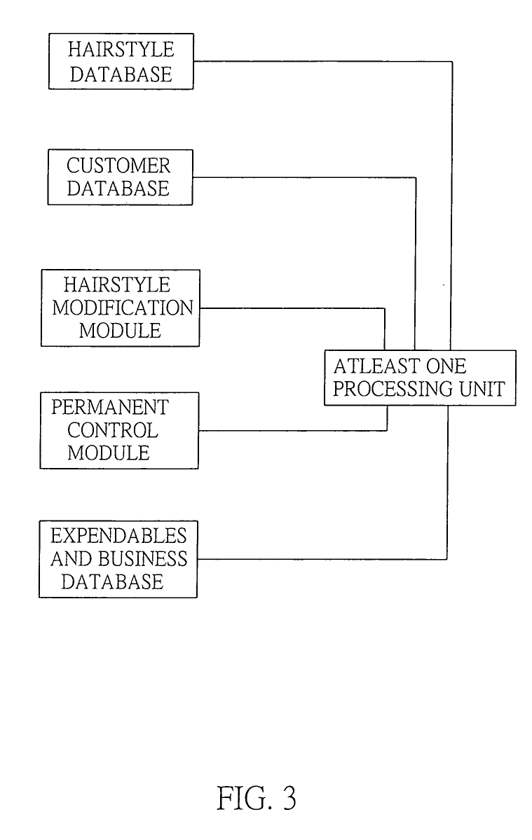

With further reference to FIG. 3, the at least one processing unit (1) is in a salon or barbershop and comprises a hairstyle database, a customer database, a hairstyle modification module, a permanent control module and an optional expendables and business database. The at least one processing unit (1) may be connected to one or more processing units (1).

The hairstyle database holds numerous hair images and three dimensional (3D) model head images. The hair images may be basic hairstyles and creations of hair stylists. The hair stylists may use a drawing, cutting, plaiting and dyeing programming tool to redesign customers' hair as a new creation and then store the creation in the hairstyle database.

The customer database stores customer information and head images.

The hairstyle modification module can call and display any hairstyle image in the hairstyle database on the monitor (10) and modify hair length, hair color and hairstyle of the hairstyle image. Furthermore, the hairstyle modification module can mate a modified hairstyle image with any customer's head image. The hairstyle modification module also allows hair stylists to create new hairstyle images.

The permanent control module computes and extrapolates control information from the hairstyle modification module and outputs permanent temperature and moisture of parameters. The parameters can be displayed on the at least one monitor (10), and the hair stylists can adjust the permanent parameters based on characteristics of a customer's hair.

The expendables and business database can input salon or barbershop expendables and expendables provided by customers. The expendables and business database can also calculate daily, monthly and yearly work of each employee, calculate salary and deduct a percentage for each hair stylist and generate a table.

The at least one monitor (10) connects to one or more other processing units (1).

The image recording device (11) is connected to the at least one processing unit (1) and may be at least one digital camera (111) or at least one digital video recorder.

The permanent device (12) is connected to the at least one processing unit (1) and may have a power supply unit (121), a cable collector unit (124), multiple permanent hair rollers (122) and one or more curling irons (123).

The power supply unit (121) connects to the at least one processing unit (1).

The cable collector unit (124) connects to the power supply unit (121).

The permanent hair rollers (122) connect to the cable collector unit (124) and receive permanent parameters computed by the permanent control module in the corresponding processing unit (1) through the cable collector unit (124), and each permanent hair roller (122) has a temperature and moisture sensor. A temperature and moisture sensor is mounted inside each permanent hair roller (122), senses hair temperature and moisture during a permanent and sends the sensed temperature and moisture to the monitor (10) through the processing unit (1).

The one or more curling irons (123) connect to the cable collector unit (124) and receive permanent parameters computed by the permanent control module in the corresponding processing unit (1) through the cable collector unit (124), and each curling iron (123) has a temperature and moisture sensor. The temperature and moisture sensor is mounted inside the curling iron (123), senses hair temperature and moisture during a permanent and sends the sensed temperature and moisture to the monitor (10) through the processing unit (1).

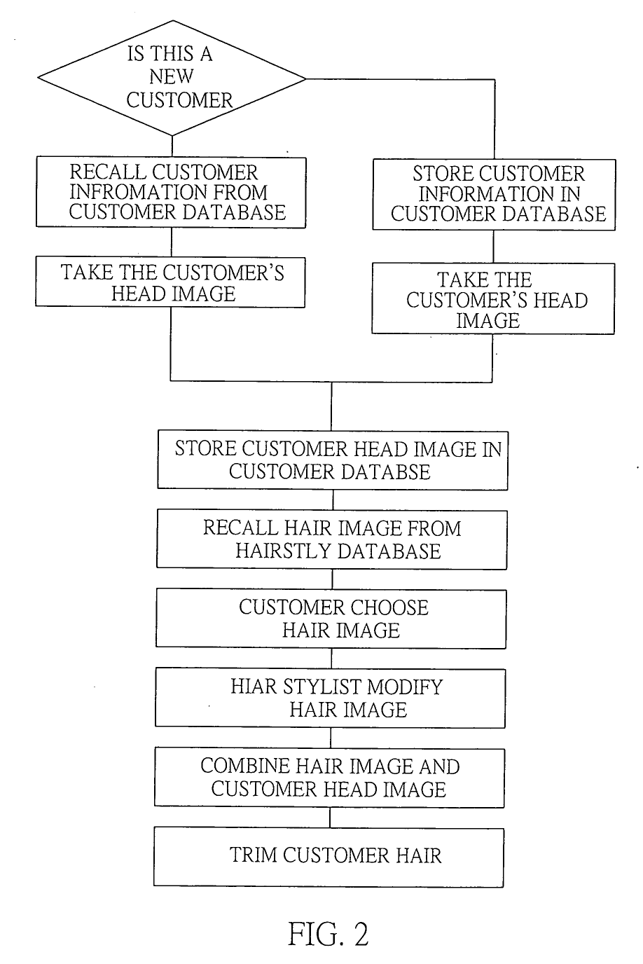

With further reference to FIG. 2, a hairstyling method in accordance with the present invention comprises acts of determining whether a customer is a new customer or an old customer, optionally inputting new customer information into a customer database, selecting a hairstyle from a hairstyle database, downloading a hair image based on the selected hairstyle, mating the hair image with a head image of the customer, modifying or redesigning the hair image until the customer is satisfied, storing the hair image in the customer database, styling the customer's hair based on the stored hair image, optionally inputting expendables and relevant business transactions into an expendables and business database, optionally using the expendables and business database to calculate employee work and salary, deducting a percentage for each hair stylist and generating a table to cover a specific period.

The act of inputting new customer information into a customer database comprises inputting the new customer's basic information into the customer database and recording the customer's head image with an image recording device of the at least one processing unit (1). If the customer revisits the barbershop or the salon, the hair stylist may recall the revisiting customer's information from the customer database of the at least one processing unit (1). The customer's information may be an image of hair of a previous hairdo.

The hair stylist may further use the image recording device (11) to take the customer's head image. The customer's head image is 2D and store in the customer database. The hair stylist may recall the 3D head image from the hairstyle database of the at least one processing unit (1). The hair stylist may use the hairstyle modification module to modify the 3D head image so that the 3D head image is able to combine with the 2D customer's head image.

The hair stylist may recall at least hair image from the hairstyle database of the at least one processing unit (1). Otherwise, the hair stylist may create at least one head image. The at least one head image displays on the at least one monitor (10) and rotates 360 degree in 3D. The customer is able to choose the hair image that the customer wishes to have the hairdo. The hair image is able to combine with the 3D head image. The hair stylist may again use the hairstyle modification module to modify the hair image. The modification of the hair image may change hair length, hair color, spacing of hair or curl of hair, braid or simulate the hair in cut, dying or permanent.

When the hair image is finished the modification, the hair stylist recalls the 2D customer's head image from the customer database. The 2D customer's head image is combined with 3D head image with hair image. The combination of the image displays in 2D on the at least one monitor (10). When the 2D images start to rotate, the 2D images show as 3D. Once again, the hair stylist may further use the hairstyle modification module to modify the image until the customer approves. If the customer can not be satisfied, the hair stylist may repeat the previously steps until the customer approves. The hair stylist may base on the image the described previously to trim the customer's hair.

If the custom further wishes to have a permanent, the permanent control module outputs the parameters of permanent. The argument of permanent and the image of hairstyle will store into the customer database of the at least one processing unit (1). The hair stylist bases on the argument of permanent to set up the permanent device (12) so that the hair stylist is able to permanent the custom's hair in controlling condition such as time of the permanent, temperature of permanent and moisture of the permanent. Based on the parameters of permanent, the hair stylist is able to use the permanent device (12) such as multiple permanent hair rollers and the at least one curling iron (123) to permanent the customer's hair.

When the customer's hairdo is done, the image recording device (11) can take head image of the customer and input the head image of the customer in to the customer database of the at least one processing unit (1) so that if the hair stylist wants to look for the customer's information in near future, the hair stylist can recall the information from the customer database of the at least one processing unit (1).

Furthermore, the hair stylist can input amount of expendables into the expendables and business database of the at least one processing unit (1). If the customers bring their own expendables and leave them at the salon or the barbershop, the hair stylist can also put amount of customers own expendables into the expendables and business database of the at least one processing unit (1). Managers are able to control the amount of expendables through the expendables and business database of the at least one processing unit (1) in a certain of time such as a day, a week, a month or a year. Furthermore, the expendables and business database of the at least one processing unit (1) is also able to count the daily business and output the data of the business into a table so that the managers are able to know the business and amount of expendables. Through the table, the managers are able to know finance of the salon or the barbershop so that the managers able to count salary of employees and the deduct a percentage for each hair stylist.

Secondly, the hair stylist can use the hairstyle database, the customer database and the hairstyle modification module to modify or create a new hair style. The new hairstyle is able to display on the at least one monitor (10) so that the hair stylist is able to know the outcome of the hairdo before the hair stylist cut someone's hair or a module. The hair stylist is able to save money and time to design the new hair style.

Thirdly, the method and apparatus for a simulative hair design by using computer programming in accordance with the present invention can be used in a hairstyle training institute. The training institute can use the invention to train students. The students are able to simulative a hairdo before the students really cut someone's hair or a model. When skills of the students are getting better through the simulation, the students can really cut someone's hair or the model. Through previously steps, the students of the training institute are able to have well training with lack of the training apparatus by using the invention.

Consequently, the customers are able to know the outcome of the hairdo before the hair stylists cut the customers' hair through the invention. Misunderstandings and arguments between the customers and the hair stylists are able to terminate before the misunderstandings and the arguments happen.

The hair stylists modify and create a new hairstyle through the invention and know the outcome of the new hairstyle before the hair stylists really cut someone's hair or a module so that the hair stylists are able to save time and money to design a new hair style.

The salon or the barbershop are able to control amount of the expendables, salary of employees and deduct a percentage for each hair stylist through the invention so that the managers of the salon or the barbershop are able to control the finance of the salon or the barbershop in more efficiency way.

The students of the training institute are able to receive well training through the invention so that the training institute with the lack of the training apparatus is able to give the students enough training by using the invention.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

what is claimed is:

1. A hairstyling method for a simulative hair design by using computer programming comprising:
A. a hair stylist using an image recording device to take a customer's head image, the customer's head image being 2D and storing in a customer database of at least one processing unit;
B. the hair stylist recalling at least one 3D head image from a hairstyle database of the at least one processing unit and the at least one 3D head image matching to fit and modifying with the 2D customer's head image;
C. The hair stylist recalling at least hair image from a hairstyle database of the at least one processing unit or creating at least one head image, the at least one head image displaying in 3D on at least one monitor, the hair image combining with the 3D head image from B;
D. a hairstyle modification module modifying the hair image From C;
E. the hair image finished the modification, the hair stylist recalling the 2D customer's head image from the customer database, the 2D customer's head image combined with 3D head image with hair image displaying in 2D and rotating on the at least one monitor, the 2D image showing as 3D;
F. a hairstyle modification module modifying the image from E until the customer agreeing the image;
G. if the image not fitting request of the customer, the hair stylist repeating the previously steps A, B, C, D, E, and F until the customer approving;
H. the hair stylist basing on the image the described previously to trim the customer's hair; and
I. a permanent control module of the at least one processing unit outputting parameters of permanent, the hair stylist basing on the argument of permanent to set up a permanent device to permanent the custom's hair that finished step H.

2. The method as claimed in claim 1, wherein the argument of permanent and image of hairstyle store into the customer database of the at least one processing unit;
when the customer' hairdo is done, the image of hairdo stores into the customer database of the at least one processing unit.

3. The method as claimed in claim 2, wherein when the hairdo is done, the hair stylist inputs amount of expendables into a expendables and business database of the at least one processing unit so that managers are able to control the amount of expendables through the expendables and business database of the at least one processing unit, the expendables and business database of the at least one processing unit counts business and output the data of the business into a table in a certain of time so that the managers are able to know the business and amount of expendables, through the table, the managers count salary of employees and the deduct a percentage for each hair stylist.

4. A hairstyling apparatus comprising
at least one processing unit having
a hairstyle database;
a customer database;
a hairstyle modification module;
a permanent control module;
an expendables and business database;
at least one monitor connecting to the at least one processing unit;
an image recording device connected to the at least one processing unit; and
a permanent device connected to the at least one processing unit.

5. The apparatus as claimed in claim 4, wherein the permanent device has:
an power supply unit;
a cable collector unit separately connected to the at least one processing unit and the power supply unit;
multiple permanent hair rollers connected to the cable collector unit; and
at least one curling iron connected to the cable collector unit.

6. The apparatus as claimed in claim 5, wherein the image recording device is at least one digital camera.

7. The apparatus as claimed in claim 5, wherein the image recording device is at least digital video record.
